(19) United States
(12) Patent Application Publication
(10) Pub. No.: US 2024/0232818 A1
(43) Pub. Date: Jul. 11, 2024

(54) ZERO-INPUT INTELLIGENCE MAINTENANCE ASSISTANT FOR A VIRTUALIZED COMPUTING ENVIRONMENT

(71) Applicant: VMware, Inc., Palo Alto, CA (US)

(72) Inventors: Wenping FAN, Beijing (CN); Yao ZHANG, Beijing (CN); Puhui MENG, Beijing (CN); Cris LAU, San Jose, CA (US); Zhikai CHEN, Beijing (CN)

(73) Assignee: VMware, Inc., Palo Alto, CA (US)

(21) Appl. No.: 18/121,602

(22) Filed: Mar. 15, 2023

(30) Foreign Application Priority Data
Jan. 9, 2023 (WO) PCT/CN2023/071262

(51) Int. Cl. G06Q 10/20; G06F 9/451; G06F 9/455

(52) U.S. Cl. CPC G06Q 10/20; G06F 9/452; G06F 9/45558; G06F 2009/45591

(57) ABSTRACT

Intelligent maintenance may be planned and performed for hosts in a pool of hosts that run virtual desktop sessions. A number of hosts to be shut down for maintenance, as well as a start time for a maintenance window, may be determined based on a first risk model and on a capacity risk level. A second risk model may be used to determine whether a capacity risk is still less than the capacity risk level, if some hosts have sessions that take longer than expected to log off and so delay the start time of the maintenance window.

### CROSS-REFERENCE TO RELATED APPLICATION

The present application claims the benefit of Patent Cooperation Treaty (PCT) Application No. PCT/CN2023/071262, filed Jan. 9, 2023, which is incorporated herein by reference.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources in a virtualized computing environment may include central processing unit (CPU) resources, memory resources, storage resources, network resources, etc.

One example use of a virtualized computing environment is for a virtual desktop infrastructure (VDI) implementation, which is a type of desktop virtualization that allows a remote desktop to run on VMs that are provided by a hypervisor on a host. During a remote desktop session, a user/client uses the operating system (OS) and applications (which reside and execute at the VM) via an endpoint device (client device) of the user, just as if the OS/applications were actually running locally on the endpoint device, when in reality the OS/applications are running on the remote desktop.

Maintenance tasks often involve shutting down or otherwise reducing operational capability of hosts that are supporting remote desktop sessions. Maintenance tasks may include, for example, installing hardware and/or software updates, diagnosing and addressing issues, performing reconfigurations, and various other tasks. It can be challenging to plan for and perform maintenance tasks in a virtualized computing environment, including VDI environments, in a manner that reduces disruptions or other adverse effects on users.

### BRIEF DESCRIPTION OF DRAWINGS

FIG. 1 is a schematic diagram illustrating an example virtualized computing environment that can implement intelligent maintenance for a virtual desktop infrastructure (VDI);

FIG. 2 is a schematic diagram illustrating an example of intelligent maintenance for the virtualized computing environment of FIG. 1;

FIG. 3 is a diagram showing a process flow for intelligent maintenance for the virtualized computing environment of FIG. 1;

FIG. 4 illustrates an example maintenance window capacity risk model;

FIG. 5 illustrates an example host maintenance capacity risk model; and

FIG. 6 is a flowchart of an example method to perform maintenance for hosts in the virtualized computing environment of FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses various drawbacks associated with planning and performing maintenance in a virtualized computing environment, including those that provide a virtual desktop infrastructure (VDI) implementation. It is not trivial for a system administrator to plan and perform maintenance tasks for a pool of hosts that run multiple remote desktop sessions. The system administrator usually has to manually plan and perform the maintenance in a rolling update manner, such as the following steps:
A. Monitoring the pool's capacity and usage, and then manually evaluate how many hosts (e.g., target hosts) can be shut down for a whole day without impacting VDI users' capability to successfully login to access virtual desktops for remote desktop sessions.
B. Manually plan the maintenance task to be performed at an idle time period (which is usually after-hours on a workday after work is done for the day or on a weekend).
C. Mark the target hosts (determined from step A above) that no longer accept new sessions for the idle time period obtained from step B above.
D. Wait for all of the sessions on the target hosts to log off, and then the target hosts can be shut down and undergo maintenance.
E. After the maintenance in the above step D finishes, manually iterate through steps A-D for other hosts in the pool.

Thus, at least some of the drawbacks and disadvantages may be as follows:
Manual planning and performance of maintenance is not efficient and is error-prone for system administrators, especially in the context of users with large multi-session pools.
In the above step D, it is unpredictable when the maintenance can be performed because the sessions are allocated in a load-balanced manner when the users login, and the last session's logoff time maybe very late. If the system administrator wants to operate more hosts in one day, doing so will bring uncontrollable capacity risk.
Due to the above step B, the number of hosts that can be operated in one round of maintenance is usually set as the buffer reserved at the beginning of the pool's capacity setup—without which the pool can still fulfill the pool users' login needs. A big buffer reservation is a wasteful cost, but a small buffer extends the maintenance by a greater number of days, which will be time-consuming for the system administrator.

The present disclosure addresses the above and other drawbacks by providing a zero-input and risk-controllable intelligent maintenance assistant, details of which are provided below. The maintenance assistant may intelligently plan and perform maintenance for hosts in a pool of hosts that run virtual desktop sessions or other types of multiple long-running tasks. A number of hosts to be shut down for maintenance, as well as a start time for a maintenance window, may be determined by the maintenance assistant based on a first risk model and on an acceptable capacity risk level. A second risk model may be used by the maintenance assistant to determine whether a capacity risk is still less than the acceptable capacity risk level, if some hosts have sessions that take longer than expected to log off and so would delay the start time of the maintenance window. If the capacity risk is determined by the maintenance assistant (based on the second risk model) to be less than the acceptable capacity risk level, then the hosts can be shut down and maintenance for the hosts can be performed; else the hosts are not shut down for maintenance.

### Computing Environment

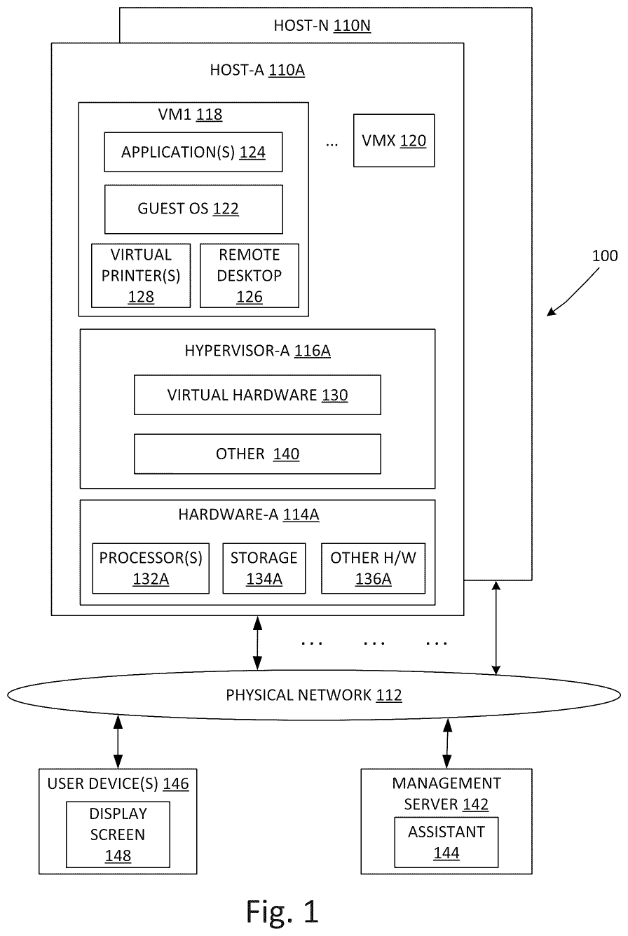

To further explain the details pertaining to performing maintenance, reference is next made herein to FIG. 1, which is a schematic diagram illustrating an example virtualized computing environment 100 that can implement intelligent maintenance for a virtual desktop infrastructure (VDI). Depending on the desired implementation, virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of the host-A 110A. Each of the other host-N 110N can include substantially similar elements and features.

The host-A 110A includes suitable hardware 114A and virtualization software (e.g., a hypervisor-A 116A) to support various virtual machines (VMs). For example, the host-A 110A supports VM1 118 . . . VMX 120, wherein X (as well as N) is an integer greater than or equal to 1. In practice, the virtualized computing environment 100 may include any number of hosts (also known as computing devices, host computers, host devices, physical servers, server systems, physical machines, etc.), wherein each host may be supporting tens or hundreds of virtual machines. For the sake of simplicity, the details of only the single VM1 118 are shown and described herein.

VM1 118 may be an agent-side VM that includes a guest operating system (OS) 122 and one or more guest applications 124 (and their corresponding processes) that run on top of the guest OS 122. The guest applications 124 may include remote desktop applications that can be accessed and used through remote desktops during a remote desktop session. Using the guest OS 122 and/or other resources of VM1 118 and the host-A 110A, VM1 118 may generate one or more remote desktops 126 (virtual desktop) that is operated by and accessible to one or more client-side user device(s) 146 (e.g., a client device or a local/endpoint device) via the physical network 112. One or more virtual printers 128 also may be instantiated in VM1 118 and/or elsewhere in the host-A 110A, and may correspond to one or more physical printers (not shown) at the user device 146. VM1 118 may include other elements, such as code and related data (including data structures), engines, etc. The user device 146 may include a display screen 148 and other components to support the use of the user device 146 to view and operate the remote desktop 126 and other elements of VM1 118.

The hypervisor-A 116A may be a software layer or component that supports the execution of multiple virtualized computing instances on the host-A 110A. The hypervisor-A 116A may run on top of a host operating system (not shown) of the host-A 110A or may run directly on hardware 114A. The hypervisor 116A maintains a mapping between underlying hardware 114A and virtual resources (depicted as virtual hardware 130) allocated to VM1 118 and the other VMs. The hypervisor-A 116A may include other elements (shown generally at 140), including tools to provide resources for and to otherwise support the operation of the VMs. In some embodiments, such other elements 140 may include components that support maintenance planning and performing maintenance tasks on the host-A 110A.

Hardware 114A in turn includes suitable physical components, such as central processing unit(s) (CPU(s)) or processor(s) 132A; storage device(s) 134A; and other hardware 136A such as physical network interface controllers (NICs), storage disk(s) accessible via storage controller(s), etc. Virtual resources (e.g., the virtual hardware 130) are allocated to each virtual machine to support a guest operating system (OS) and application(s) in the virtual machine, such as the guest OS 122 and the application(s) 124 (e.g., a word processing application, accounting software, a browser, etc.) in VM1 118. Corresponding to the hardware 114A, the virtual hardware 130 may include a virtual CPU, a virtual memory (including agent-side caches used for print jobs for the virtual printers 128), a virtual disk, a virtual network interface controller (VNIC), etc.

A management server 142 of one embodiment can take the form of a physical computer with functionality to manage or otherwise control the operation of host-A 110A . . . host-N 110N. In some embodiments, the functionality of the management server 142 can be implemented in a virtual appliance, for example in the form of a single-purpose VM that may be run on one of the hosts in a cluster or on a host that is not in the cluster.

The management server 142 may be communicatively coupled to host-A 110A . . . host-N 110N (and hence communicatively coupled to the virtual machines, hypervisors, hardware, etc.) via the physical network 112. In some embodiments, the functionality of the management server 142 may be implemented in any of host-A 110A . . . host-N 110N, instead of being provided as a separate standalone device such as depicted in FIG. 1.

The management server 142 may be configured to manage the operation of various components of the virtualized computing environment 100, including but not limited to, planning and performing maintenance, troubleshooting, monitoring resource usage, resource allocation and capacity planning, security, configuration, and other operations pertaining to managing the operation of the hosts, VMs, etc. in the virtualized computing environment 100. With respect to maintenance, the management server 142 may include a maintenance assistant 144.

The maintenance assistant 144 may be configured to plan and/or perform maintenance for the hosts and/or other components in the virtualized computing environment 100. The maintenance assistant 144 of various embodiments may be a zero-input intelligent maintenance assistant, in that the maintenance assistant 144 can determine the number of hosts for which maintenance is to be performed and when (e.g., a start time) of maintenance window to perform the maintenance, without necessarily needing know in advance (in the form of input) as to one or more of: which hosts need maintenance, the number hosts needing maintenance, time of the maintenance, duration of the maintenance window, etc. Details regarding the operation of the maintenance assistant 144 will be described in further detail below.

The maintenance assistant 144 may reside at the maintenance server 142 as depicted in FIG. 1. In other embodiments, the maintenance assistant 144 (and/or components thereof) may reside alternatively or additionally at other devices, such as the other components 140 at the host(s) or elsewhere. The maintenance assistant 144 may be a distributed tool in some embodiments, with various components thereof residing and executing at different devices.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

### Intelligent Maintenance

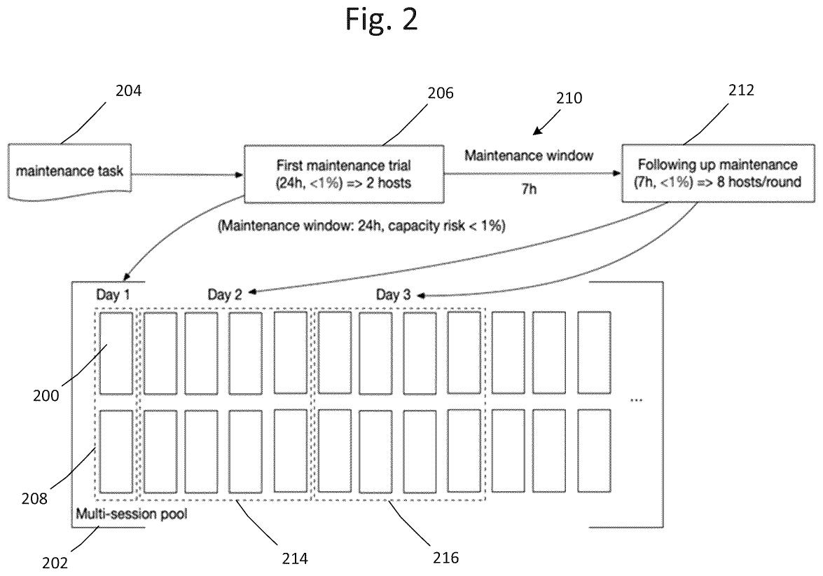

FIG. 2 is a schematic diagram illustrating an example of intelligent maintenance for the virtualized computing environment 100 of FIG. 1. A plurality of hosts 200 may be a present in a pool 202 of hosts (amongst host-A 110A . . . host-N 110N of FIG. 1) that are each running multiple sessions. For example, each host in the pool 202 may be supporting one or more VMs (e.g., the VM1 118) that is running one or more virtual desktop sessions.

In an example of a zero-input maintenance process, at least one maintenance task 204 for the pool 202 is performed during a first maintenance trial 206. The first maintenance trial 206 attempts to determine how long (e.g., a length of time, for instance in hours) that the maintenance task 204 will take to complete for at least some of the hosts 200 in the pool 202, so that the process can be accelerated for the subsequent maintenance of the other hosts in the pool 202.

For the first maintenance trial 206, a maintenance window is set at a maximum time of 24 hours so as to minimize the capacity risk during the day. The maintenance window is a time frame during which maintenance is performed and completed for all of the hosts involved in a round of maintenance. The capacity risk may be a value that represents a risk that may be tolerated in the pool 202 if a certain number of hosts 200 are shut down for maintenance during a maintenance window. For example, a capacity risk of 1% may represent that the pool 202 can meet up to 99% of the need (e.g., can support up to 99% of virtual desktop sessions) during the maintenance window in which some hosts are shut down for maintenance. As another example, a capacity risk may be an upper limit risk that the pool 202 can tolerate in terms of hosts having insufficient capacity to handle sessions (e.g., the pool 202 can still handle sessions if the pool has lost 1% of its capacity). Other ways of quantifying or representing the capacity risk may be used.

According to various embodiments, the capacity risk (e.g., 1%), as well as the maintenance window (e.g., 24 hours), may be configured by a system administrator. The capacity risk and maintenance window may be provided as input to the maintenance assistant 144 of FIG. 1.

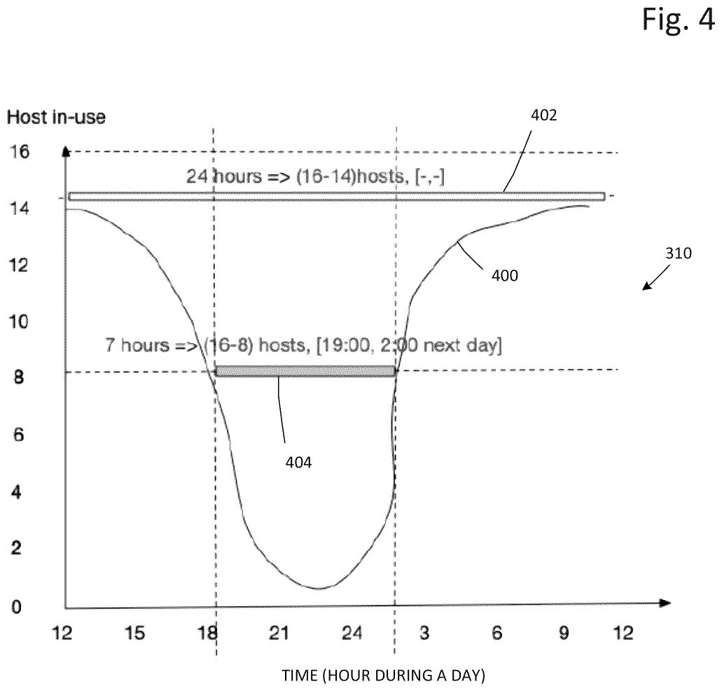

According to a maintenance window capacity risk model (e.g., a first risk model) and as an example, the maintenance assistant 144 determines that 2 hosts may be shut down for maintenance during the first maintenance trial 206, in order to meet the requirement of the capacity risk being less than 1% for 24 hours. These 2 hosts are shown in FIG. 2 for a first maintenance window 208 that has been set to span day 1 (e.g., 24 hours) for the first maintenance trial 206. The use of the maintenance window capacity risk model to determine the number of hosts to shut down in each maintenance window will be explained further below with respect to FIG. 4.

The maintenance is then performed for the 2 hosts during the first maintenance window 208, while other hosts in the pool 202 continue to operate so as to support and run multiple sessions. The maintenance assistant 144 then determines (e.g., provided as an output at 210) that it took a time span of 7 hours (for example) to complete the maintenance for the 2 hosts during the first maintenance window 208.

For the subsequent (follow up) maintenance 212 of additional/next hosts in the pool 202, their maintenance window can be shortened to a time span of 7 hours, based on the result of the first maintenance trial 206. For instance, the capacity risk decreases during the subsequent maintenance window(s) and so more hosts can undergo maintenance. One reason for the decrease in capacity risk is that some hosts (e.g., the 2 hosts) in a previous maintenance window have already completed their maintenance, and so such hosts are operational and available to handle sessions.

In the example of FIG. 2, the maintenance assistant 144 can use the maintenance window capacity risk model to determine that 8 hosts can undergo maintenance in day 2 (in a second maintenance window 214), and also in day 3 (in a third maintenance window 216), etc., with each maintenance window spanning 7 hours. The overall maintenance process can thus be accelerated.

While it is noted that the second maintenance window 214 and the third maintenance window 216 (each having a time span of 7 hours) are depicted in the example of FIG. 2 as occurring on respective separate days 2 and 3, it is possible in some embodiments to perform maintenance for these and/or other maintenance windows within a single day, dependent on whether the total duration of the maintenance window(s) will fit within the 24 hours of a single day.

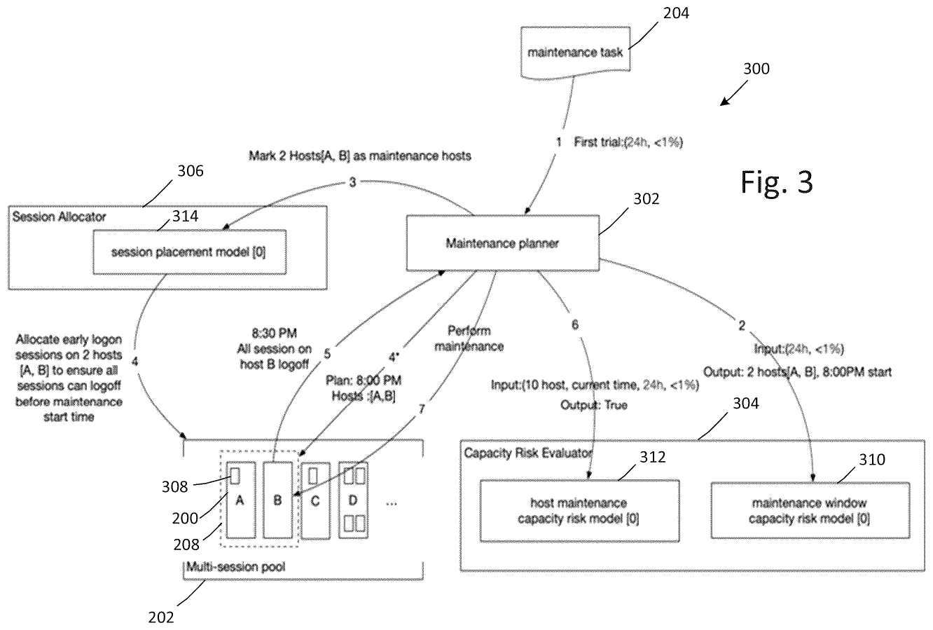

According to various embodiments, the process flow for each maintenance window 214, 216, etc. can be the same as the maintenance process flow for the first maintenance window 208. Example details of the process flow for maintenance will be described next below with respect to FIG. 3.

More specifically, FIG. 3 is a diagram showing a process flow 300 for intelligent maintenance for the virtualized computing environment 100 of FIG. 1. In one embodiment, the operations of the process flow 300 and/or of any other process(es)/method(s) described herein may be performed in a pipelined sequential manner. In other embodiments, some operations may be performed out-of-order, in parallel, etc., and need not necessarily be performed in the exact order shown. Furthermore, various blocks, operations, steps, etc. depicted in the process flow 300 and/or in any other process(es)/method(s) described herein may be modified, combined, omitted, supplemented with other operations, etc. in various embodiments.

According to one embodiment, at least some of operations in the process flow 300 may be performed by the maintenance assistant 144. In other embodiments, various other elements in a computing environment may perform, individually or cooperatively with the maintenance assistant 144, the various operations of the process flow 300.

Furthermore, the process flow 300 will be described herein using various specific values for number of hosts, duration of maintenance windows, start times, capacity risk, etc. It is understood that such specific values are illustrative examples and are being used to describe the process flow 300 and other processes/methods in this disclosure merely for convenience for purposes of identification and reference, and are not intended to restrict the embodiments to the specific values and implementations that are described. For instance, other embodiments may implement other values for capacity risk, number of hosts, duration of maintenance windows, etc.

FIG. 3 depicts components of the maintenance assistant 144 that may be configured to perform the operations of the process flow 300, including a maintenance planner 302, a capacity risk evaluator 304, and a session allocator 306. FIG. 3 also shows the pool 202 having the hosts 200 (e.g., hosts A-D etc.), with each host running 0 or more sessions 308.

At a step 0, a maintenance window capacity risk model 310 (e.g., the first risk model), a host maintenance capacity risk model 312 (e.g., a second risk model), and a session placement model 314 (e.g., a third model) may be pre-built. In the example shown in FIG. 3, the maintenance window capacity risk model 310 and the host maintenance capacity risk model 312 may reside in or may be otherwise accessible to and used by the capacity risk evaluator 304, while the session placement model 314 may reside in or may be otherwise accessible to and used by the session allocator 306. The capacity risk evaluator 304 and the session allocator 306 may also be configured to update, revise, or otherwise maintain their respective models.

As will be described in further detail below, the maintenance window capacity risk model 310 may be used to determine a host count for maintenance, and when to perform maintenance on the hosts in the host count for a particular duration/length of a maintenance window and at an accepted capacity risk level (e.g., the above-described capacity risk level of 1%). As will also be described in further detail below, the host maintenance capacity risk model 312 may be used to confirm (e.g., double confirm) that the capacity risk is still under the accepted level (e.g., 1%) when the power off time of the host(s) in the maintenance window is later than originally planned.

The session placement model 314 may be used for grouping remote desktop sessions on hosts according to predicted user logoff times so that sessions with similar predicted logoff times can be placed together on the hosts, thereby allowing for more efficient utilization and maintenance of the hosts. Examples of techniques build a session placement model and to group remote desktop sessions by the session placement model are described in U.S. patent application Ser. No. 17/392,297, entitled “ADAPTIVE VIRTUAL DESKTOP SESSION PLACEMENT ON HOST SERVERS VIA USER LOGOFF PREDICTION,” filed on Aug. 3, 2021, which is incorporated herein by reference in its entirety.

To perform one or more maintenance tasks 204 for the hosts 200 in the pool 208, a step 1 involves providing inputs to the maintenance planner 302 for the first maintenance trial 206. As previously explained above with respect to FIG. 2, these inputs for the first maintenance trial 206 may be a value of 24 hours for the first maintenance window 208 and a value of 1% (e.g., a level of 1% or less) for the capacity risk.

At a step 2, the maintenance planner 302 provides the above inputs to the capacity risk evaluator 304, which uses the maintenance window capacity risk model 310 to determine and provide an output that indicates the number of hosts (e.g., 2 hosts) to undergo maintenance during the first maintenance window 208 and the start time of the maintenance (e.g., start at 8:00 PM).

At a step 3, the maintenance planner 302 marks/identifies the 2 hosts (e.g., the hosts A and B) for maintenance. The maintenance planner 302 informs the session allocator 306 of these hosts A and B that are to undergo maintenance.

At a step 4, the session allocator 306 uses the session placement model 314 to allocate the earliest/oldest logon sessions to the two hosts A and B, so as to ensure that all of the sessions on these hosts A and B can be logged off before the start time of the maintenance. At a step 4*, the maintenance planner 302 informs the hosts A and B that their maintenance (including shut down) is planned to start at the maintenance start time of 8:00 PM. Note that in this example of FIG. 3, the notation used to identify the steps 4 and 4* indicates that there is no sequence order in these two steps, for some embodiments.

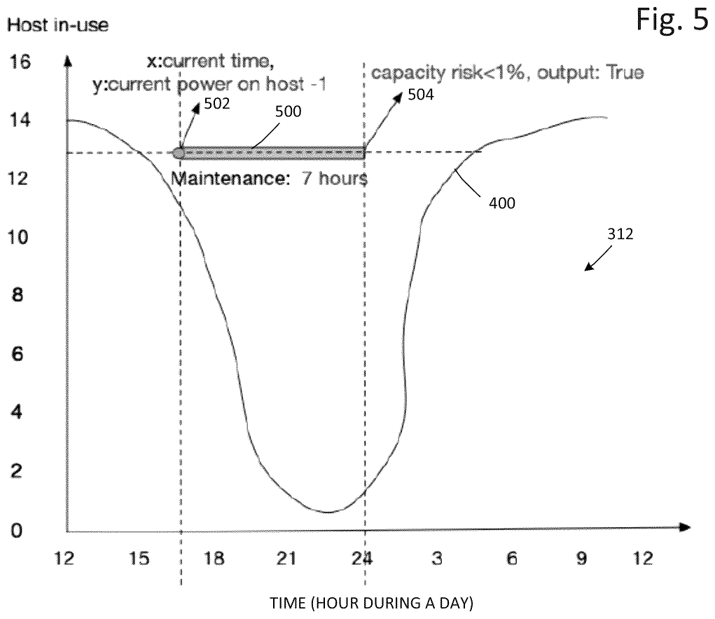

In a step 5, a risk scenario is provided in which the sessions on the target hosts A and B last longer than expected, for example, the last session on the host B logs off at 8:30 PM rather than before 8:00 PM as originally planned. In such a scenario, the maintenance assistant 144 can still ensure that the capacity risk is controllable (e.g., remains at 1% or less), by using the capacity risk evaluator 304 to use the host maintenance capacity risk model 312 to evaluate the capacity risk, before shutting down the host B. This may be done at a step 6, in which the maintenance planner 302 provides the following as input to the capacity risk evaluator 304: the number of hosts (e.g., 10 hosts), the current time, the duration of the first maintenance window 208 (e.g., 24 hours), and the capacity risk (e.g., 1%). The input of 10 hosts may be calculated, for example, by counting how many hosts remain powered on if the target host is powered off. The capacity risk evaluator 304 may then determine whether the capacity risk of 1% or less will still be maintained if 10 hosts are powered on for a time range of [current time, current time+maintenance window]. Further example details are provided below with respect to FIG. 5.

If the capacity risk evaluator 304 determines (from the host maintenance capacity risk model 312) that the capacity risk is still less than the acceptance level (e.g., under 1%) when the power off time for the host(s) is later than originally planned, then the capacity risk evaluator 304 provides an output to confirm this condition (e.g., an output of True) at step 6, else an output of False is provided.

The maintenance planner 302 then initiates the performance of the maintenance at a step 7, including shutting down both hosts A and B at 8:30 PM or shortly afterwards, after the last session has logged off.

FIG. 4 illustrates an example of the maintenance window capacity risk model 310 (e.g., a first risk model) that may be used in step 2 of the process flow 300 of FIG. 3. As previously explained above, one purpose for the maintenance window capacity risk model 310 is to determine a count of hosts to undergo maintenance and to determine when to perform the maintenance in view of the constraints of the length of the maintenance window length and accepted risk level (e.g., 1%).

In FIG. 4: the x-axis represents time in terms of each hour in a 24-hour day; the y-axis shows the count of a number of hosts in-use in the pool 202; and a curve 400 of statistical values obtained from historical data. For example, the curve 400 may be a 99th percentile hosts in-use curve.

Given the trend shown by the curve 400 (e.g., the 99th percentile host in-use curve), the goal of the maintenance window capacity risk model 310 is to identify a horizontal line having a length (being the length of a maintenance window) and that never comes across the 99% percentile host in-use curve. This condition provided by the horizontal line indicates that the power-on host count (during the maintenance window)>host in-use count, at the 1% risk level.

Then, the number of hosts that can be shut down for maintenance can be determined from the line's y-axis value, and the optimal maintenance window can be determined from the line's x-axis values (e.g., the start time and the end time of the maintenance window).

Thus, for the first maintenance trial 206 that spans the first maintenance window 208, inputs to the maintenance window capacity risk model 310 are the length of the first maintenance window 208 (e.g., 24 hours) and the capacity risk (e.g., a risk level of 1% as a maximum). The corresponding output of the maintenance window capacity risk model 310 is represented by a horizontal line 402 that never crosses the curve 400 and indicating that 16-14 hosts=2 hosts can be shut down for maintenance during the first maintenance trial 206, as represented by the y-axis of the horizontal line 206. The x-axis of the horizontal line 402 indicates start and end times of [−, −] for the maintenance window, since the maintenance window has been set to a length of 24 hours.

When maintenance is then performed and completed for these 2 hosts for the first maintenance trial 206 during the first maintenance window 208, the results may indicate that the maintenance was completed in a time span of 7 hours. According to various embodiments and as previously described above with respect to FIG. 2, this completion time (e.g., the time span of 7 hours) for the first maintenance trial 206 may be used as the length of the maintenance window for the next round of maintenance.

In FIG. 4 and based on an input of a time span of 7 hours for the length of the maintenance window and a capacity risk of 1%, the maintenance window capacity risk model 310 is able to identify a horizontal line 404 that never crosses the curve 400. The length of the horizontal line 404 is a time span of 7 hours, at a maintenance start time of 19:00 hours and a maintenance end time of 2:00 hours of the next day. The y-axis of the horizontal line 404 is at 16-8 hosts=8 hosts that can be shut down for the second maintenance window 214 of this next round of maintenance 212 (such as also shown in FIG. 2). Hence, the outputs the maintenance window capacity risk model 310 indicate 8 hosts to be shut down for maintenance, with a maintenance start time of 19:00 hours and a maintenance end time of 2:00 hours of the next day, for the next maintenance window 214.

FIG. 5 illustrates an example of the host maintenance capacity risk model 312 (e.g., a second risk model) that may be used in step 6 of the process flow 300 of FIG. 3. The curve 400, y-axis, and x-axis of FIG. 5 are shown and labeled similarly as in FIG. 4. As previously explained above, the host maintenance capacity risk model 312 may be used by the capacity risk evaluator 304, and is called when all of the sessions on the target hosts (e.g., the hosts that are in the maintenance round/plan) have logged off.

One purpose of the host maintenance capacity risk model 312 is to double confirm that the capacity risk is still less than the acceptance level (e.g., under 1%) when the power off time of the target hosts in the maintenance round is later than originally planned. Similar as the maintenance window capacity risk model 310 of FIG. 4, the host maintenance capacity risk model 312 of FIG. 5 is also based on the curve 400 (e.g., a 99% percentile host in-use curve) obtained from historical data.

A horizontal line 500 starts at a point 502, which corresponds to a current time on the x-axis and a power on host count −1 on the y-axis, and which are provided as input for the host maintenance capacity risk model 312. The length of the horizontal line 500 is the length of the maintenance window (e.g., a time span of 7 hours), which is also provided as input along with the 1% level for the capacity risk.

If the horizontal line 500 never comes across the curve 400, then the capacity risk is determined by the maintenance capacity risk model 312 to be still less than 1% when the target host(s) powers off, and so that the target host(s) can undergo maintenance during this maintenance round. The output of the host maintenance capacity risk model 312 is therefore Output: True. If the horizontal line 500 crosses the curve 400, thereby indicating that the capacity risk is no longer less than 1%, then the host maintenance capacity risk model 312 provides an output to indicate that target host(s) cannot or should not be shut down for maintenance (e.g., Output: False).

In the example of FIG. 5, the power on host count—1=14-1 hosts=13 hosts, and the current time (when all of the sessions have been logged off the target host(s)) is at 17:00 hours. The length of the maintenance window spans 7 hours, thereby ending at 24:00 hours. During the entire span of 7 hours, the horizontal line 500 never crosses the curve 400, thereby indicating that the target host(s) can undergo maintenance (e.g., Output: True).

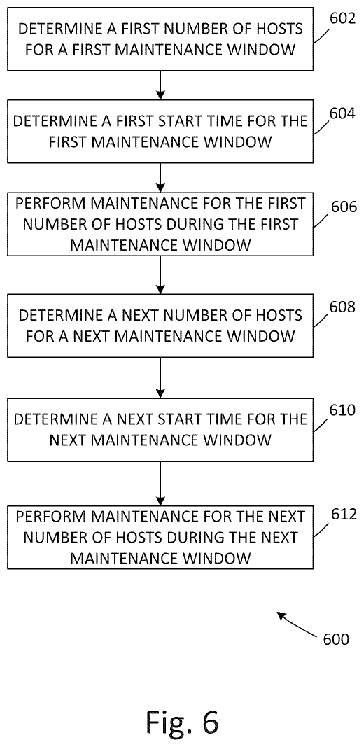

FIG. 6 is a flowchart of an example method 600 to perform maintenance for hosts in the virtualized computing environment 100 of FIG. 1. At least some of the operations in the method 600 may be performed by the maintenance assistant 144 of FIG. 1, which may run on the management server 142 and/or on other computing device(s).

At a block 602 (“DETERMINE A FIRST NUMBER OF HOSTS FOR A FIRST MAINTENANCE WINDOW”), a first number of hosts to undergo maintenance during a first maintenance window may be determined by the maintenance assistant 144. For instance and as previously described above, the first number of hosts for the first maintenance window 208 of the first maintenance trial 206 may be determined as 2 hosts, based on the maintenance window capacity risk model 310 (e.g., the first risk model) and on the capacity risk level (e.g., 1%).

At a block 604 (“DETERMINE A FIRST START TIME FOR THE FIRST MAINTENANCE WINDOW”), the maintenance assistant 144 may determine a first start time for the first maintenance window 208. The first start time may be, for example, a time when all sessions of the first number of hosts have (or are expected to have) logged off.

At a block 606 (“PERFORM MAINTENANCE FOR THE FIRST NUMBER OF HOSTS DURING THE FIRST MAINTENANCE WINDOW”), maintenance is performed for the first number of hosts. For instance, the first number of hosts are shut down, and then maintenance is performed on the shut down hosts. Performing the maintenance may begin at the first start time and is completed in a time span (e.g., 7 hours in the examples described above) after the first start time.

At a block 608 (“DETERMINE A NEXT NUMBER OF HOSTS FOR A NEXT MAINTENANCE WINDOW”), the maintenance assistant 144 determines a next number of hosts for a next maintenance window (e.g., the second maintenance window 214). For instance and as previously explained above, the next number of hosts may be determined as 8 hosts, also based on the maintenance window capacity risk model 310 (e.g., the first risk model) and on the capacity risk level (e.g., 1%). The length of the next maintenance window at the block 608 may be equal to the above time span (e.g., 7 hours).

At a block 610 (“DETERMINE A NEXT START TIME FOR THE NEXT MAINTENANCE WINDOW”), the maintenance assistant 144 determines the start time of the next maintenance window (e.g., the second maintenance window 214), also based on the maintenance window capacity risk model 310 (e.g., the first risk model) and on the capacity risk level (e.g., 1%).

At a block 612 (“PERFORM MAINTENANCE FOR THE NEXT NUMBER OF HOSTS DURING THE NEXT MAINTENANCE WINDOW”), maintenance is performed for the next number of hosts (e.g., the 8 hosts) during the second maintenance window 214, starting at the next start time determined at the block 610.

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-6. For example, computing devices capable of providing capabilities of the maintenance assistant 144 as described herein may be deployed in or otherwise operate in conjunction with the virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances (VCIs) may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment), wherein it would be beneficial to perform intelligent maintenance.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method for maintenance of hosts in a pool of hosts, the method comprising:
determining a first number of hosts in the pool to undergo maintenance during a first maintenance window;
determining a first start time for the first maintenance window, wherein the first number of hosts is determined based on a first risk model and on a capacity risk level, and wherein the first start time corresponds to when sessions on the first number of hosts have logged off;
performing maintenance on the first number of hosts during the first maintenance window, wherein performing the maintenance starts at the first start time and is completed in a time span after the first start time;
determining a next number of hosts in the pool to undergo maintenance during a next maintenance window, wherein a length of the next maintenance window is equal to the time span;
determining a next start time for the next maintenance window, wherein the next number of hosts and the next start time are determined based on the first risk model and on the capacity risk level; and
performing maintenance on the next number of hosts during the next maintenance window, starting at the next start time.

2. The method of claim 1, wherein performing the maintenance on the first number of hosts is based on a second risk model, and wherein the second risk model provides an indication of whether a capacity risk is less than the capacity risk level if the maintenance on the first number of hosts is to start after the first start time due to the sessions on the first number of hosts having logged off after the first start time.

3. The method of claim 2, wherein:
the maintenance on the first number of hosts is performed if the second risk model indicates that the capacity risk is less than the capacity risk level, and
the maintenance on the first number of hosts is not performed if the second risk model indicates that the capacity risk is greater than the capacity risk level.

4. The method of claim 1, further comprising:
allocating the sessions to the first number of hosts based on a third model, wherein the third model is used to identify the allocated sessions as being sessions in the pool that are oldest.

5. The method of claim 1, wherein the sessions include remote desktop sessions that run on the first number of hosts.

6. The method of claim 1, wherein the first risk model is based at least in part on historical data.

7. The method of claim 1, wherein the first number of hosts is determined based on the first risk model as being a number of hosts in the pool that are allowed to be shut down while keeping a capacity risk of the pool less than the capacity risk level.

8. A non-transitory computer-readable medium having instructions stored thereon, which in response to execution by one or more processors, cause the one or more processors to perform a method for maintenance of hosts in a pool of hosts, wherein the method comprises:
determining a first number of hosts in the pool to undergo maintenance during a first maintenance window;
determining a first start time for the first maintenance window, wherein the first number of hosts is determined based on a first risk model and on a capacity risk level, and wherein the first start time corresponds to when sessions on the first number of hosts have logged off;
performing maintenance on the first number of hosts during the first maintenance window, wherein performing the maintenance starts at the first start time and is completed in a time span after the first start time;
determining a next number of hosts in the pool to undergo maintenance during a next maintenance window, wherein a length of the next maintenance window is equal to the time span;
determining a next start time for the next maintenance window, wherein the next number of hosts and the next start time are determined based on the first risk model and on the capacity risk level; and
performing maintenance on the next number of hosts during the next maintenance window, starting at the next start time.

9. The non-transitory computer-readable medium of claim 8, wherein performing the maintenance on the first number of hosts is based on a second risk model, and wherein the second risk model provides an indication of whether a capacity risk is less than the capacity risk level if the maintenance on the first number of hosts is to start after the first start time due to the sessions on the first number of hosts having logged off after the first start time.

10. The non-transitory computer-readable medium of claim 9, wherein:
the maintenance on the first number of hosts is performed if the second risk model indicates that the capacity risk is less than the capacity risk level, and
the maintenance on the first number of hosts is not performed if the second risk model indicates that the capacity risk is greater than the capacity risk level.

11. The non-transitory computer-readable medium of claim 8, wherein the method further comprises:
allocating the sessions to the first number of hosts based on a third model, wherein the third model is used to identify the allocated sessions as being sessions in the pool that are oldest.

12. The non-transitory computer-readable medium of claim 8, wherein the sessions include remote desktop sessions that run on the first number of hosts.

13. The non-transitory computer-readable medium of claim 8, wherein the first risk model is based at least in part on historical data.

14. The non-transitory computer-readable medium of claim 8, wherein the first number of hosts is determined based on the first risk model as being a number of hosts in the pool that are allowed to be shut down while keeping a capacity risk of the pool less than the capacity risk level.

15. A computing device, comprising:
a processor; and
a non-transitory computer-readable medium coupled to the processor and having instructions stored thereon, which in response to execution by the processor, cause the processor to perform or control performance of operations for maintenance of hosts in a pool of hosts, wherein the operations comprise:
determine a first number of hosts in the pool to undergo maintenance during a first maintenance window;
determine a first start time for the first maintenance window, wherein the first number of hosts is determined based on a first risk model and on a capacity risk level, and wherein the first start time corresponds to when sessions on the first number of hosts have logged off;
perform maintenance on the first number of hosts during the first maintenance window, wherein performing the maintenance starts at the first start time and is completed in a time span after the first start time;
determine a next number of hosts in the pool to undergo maintenance during a next maintenance window, wherein a length of the next maintenance window is equal to the time span;
determine a next start time for the next maintenance window, wherein the next number of hosts and the next start time are determined based on the first risk model and on the capacity risk level; and
perform maintenance on the next number of hosts during the next maintenance window, starting at the next start time.

16. The computing device of claim 15, wherein the operations to perform the maintenance on the first number of hosts is based on a second risk model, and wherein the second risk model provides an indication of whether a capacity risk is less than the capacity risk level if the maintenance on the first number of hosts is to start after the first start time due to the sessions on the first number of hosts having logged off after the first start time.

17. The computing device of claim 16, wherein:
the maintenance on the first number of hosts is performed if the second risk model indicates that the capacity risk is less than the capacity risk level, and
the maintenance on the first number of hosts is not performed if the second risk model indicates that the capacity risk is greater than the capacity risk level.

18. The computing device of claim 15, wherein the operations further comprise:
allocate the sessions to the first number of hosts based on a third model, wherein the third model is used to identify the allocated sessions as being sessions in the pool that are oldest.

19. The computing device of claim 15, wherein the sessions include remote desktop sessions that run on the first number of hosts.

20. The computing device of claim 15, wherein the first risk model is based at least in part on historical data.

21. The computing device of claim 15, wherein the first number of hosts is determined based on the first risk model as being a number of hosts in the pool that are allowed to be shut down while keeping a capacity risk of the pool less than the capacity risk level.
